(19) United States
(12) Patent Application Publication
(10) Pub. No.: US 2009/0167762 A1
(43) Pub. Date: Jul. 2, 2009

(54) System and Method for Creating Shaders Via Reference Image Sampling

(76) Inventor: Ofer Alon, Forest City, CA (US)

Correspondence Address: CHRISTIE, PARKER & HALE, LLP, PO BOX 7068, PASADENA, CA, 91109-7068, US

(21) Appl. No.: 11/964,672

(22) Filed: Dec. 26, 2007

(51) Int. Cl. G06T 15/50

(52) U.S. Cl. 345/426

(57) ABSTRACT

A system and method for creating a surface shader based on material surface shading information of a reference image. A user interface is provided which allows an artist to place various markers on the reference image. One or more points on the reference image identified by the placed markers are sampled for obtaining shading information for the sampled points. A 2D image is then generated with the obtained shading information. As markers are added or existing markers replaced on the reference image, the 2D image is updated in real time to provide feedback to the user of the surface shader that is being created. The surface shader is then used to render a 3D object.

### CROSS-REFERENCE TO RELATED APPLICATION(S)

This application claims the benefit of U.S. Application Ser. No. 60/876,669, filed on Dec. 22, 2006, the content of which is incorporated herein by reference.

### FIELD OF THE INVENTION

This invention relates generally to surface shading of 3D computer generated objects, and more specifically, to a process for creating surface shaders via capture and calibration from images that show examples of the surface shading.

### BACKGROUND OF THE INVENTION

3D rendering is a process of producing a visual representation of three-dimensional data. The three-dimensional data that is depicted could be a complete scene including geometric models of different three-dimensional objects, buildings, landscapes, and animated characters. One important component of 3D rendering is the process of combining material properties and surface shaders to produce a desired look of the three-dimensional data. Material properties are a set of numerical values that describe the way that the surface of the object reacts to the environment in which it is placed. The rendering phase usually requires the user (generally an artist) to execute multiple renderings cycles while adjusting the material properties until a desired look of the surface is achieved. This trial-and-error phase is time consuming, unintuitive, and requires the user to have a good understanding of the various material-properties and how they need to be adjusted in order to achieve a desired look. Accordingly, what is desired is a more efficient and more intuitive system and method for rendering 3D objects.

### SUMMARY OF THE INVENTION

Various embodiments of the present invention help improve on prior technology by allowing the user to quickly capture the appearance of a surface material from samples or work generated by the artist, and to apply that captured look to the surface of other 3D computer generated models. In this regard, a system and method is provided for creating a surface shader based on material surface shading information of a reference image. The present invention is also directed to a computer readable media embodying program instructions for execution by a processing device which adapts the processing device for creating and applying such a surface shader.

According to one embodiment of the invention, an intuitive user interface allows an artist to place various markers on the reference image. The markers may take the form of vectors. One or more points on the reference image identified by the placed markers are sampled for obtaining shading information for the sampled points. The shading information is then used to render a 3D object.

According to one embodiment of the invention, the shaded 3D object depicts a surface appearance of the reference image surrounding the sampled points.

According to one embodiment of the invention, the sampling of the one or more points includes obtaining color information for the one or more points, and/or obtaining an orientation of the placed markers.

According to one embodiment of the invention, the shading information includes color, orientation, and specularity for the one or more points. The specularity may be interactively determined for each marker responsive to a user manipulation of a user input device.

According to one embodiment of the invention, a 2D image is generated with the obtained shading information for testing a rendering based on the shading information. The 2D image may be a hemisphere which may be updated in real-time in response to the placement of each marker. The 2D image may depict a surface appearance of the reference image surrounding the sampled points. When the 2D image is used to shade a 3D object, the shaded 3D object may depict a surface appearance of the 2D image.

Thus, a person of skill in the art should appreciate that the invention according to the above embodiments allows the capture of the surface appearance (or look), including lighting, shading, and color, from a predefined image on a computer or even a real-world image or object, to create a surface shader than can then be applied to an arbitrary 3D object. By enabling the artist to define the surface shader by sampling existing images (e.g. photographs, computer generated images, illustration, and the like), the need to understand and modify large number of numerical values, such as, for example, numerical material properties, lighting parameters, and other environmental effects, is eliminated and/or reduced to a simple and intuitive process. An intuitive user interface allows the artist to capture the properties of a material's look. Other workflows will additionally allow the capture of the look of a material that an artist has painted onto a 3D object or to an image on a computer. The present invention has a wide range of end uses, such as, for example, photo-enhancement, matte painting for film production, and application of common materials, such as plastic or gold, to existing models.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIGS. 1-2 are photographic images of a user interface for placing markers at various points of a reference image for capturing and calibrating shading information of the surface surrounding the points according to one embodiment of the invention;

FIG. 3 is a photographic image of a 3D computer generated object rendered according to the shading information captured from the reference image of FIGS. 1-2 according to one embodiment of the invention;

FIG. 4A is a photographic image of a user interface for placing makers at various points of an image of a statute for capturing and calibrating shading information of the surface surrounding the various points according to one embodiment of the invention;

FIG. 4B is a photographic image of a 3D computer model rendered according to the shading information captured from the image of the statute of FIG. 4A according to one embodiment of the invention;

FIG. 5 is a photographic image of an alternative user interface using fixed markers on a hemisphere for quickly specifying a surface material's properties according to one embodiment of the invention;

FIG. 6 is a photographic image of a second alternative user interface providing predefined surface type areas that are colored by an artist to specify a surface material's properties according to one embodiment of the invention;

FIG. 7A is a flow diagram of a process for sampling points in a reference image for capturing and calibrating shading information of the surface surrounding the sampled points according to one embodiment of the invention;

FIG. 7B is a flow diagram of a process for generating a hemisphere image with the shading information of the sampled points in FIG. 7A according to one embodiment of the invention;

FIG. 7C is a flow diagram of a process for using the hemisphere image of FIG. 7B for rendering an arbitrary 3D object according to one embodiment of the invention;

FIG. 8 is a flow diagram of an exemplary prior art process for defining surface appearance for rendering a 3D object;

FIG. 9 is a flow diagram of an improved process for creating a surface shader for rendering a 3D object according to various embodiments of the invention; and

FIG. 10 is a schematic block diagram of a system for creating and applying surface shaders according to one embodiment of the invention.

### DETAILED DESCRIPTION OF THE INVENTION

The appearance of object surfaces in the real world is primarily determined by two factors: (1) the lighting environment for an object (sunlight, area lights such as a fluorescent light panel, or more complex lighting sources such as a string of Christmas lights); and (2) the optical surface properties of the object (color, shininess, and others). Within the field of 3D computer graphics, these effects are typically obtained by setting up a simulated lighting environment, and by implementing and using various types of algorithms to simulate the way in which surfaces respond to light. Such algorithms are known as shading models. Most shading models use the normal at a point on a surface, which is a vector in the direction that is perpendicular to the surface at that point, and which points to the outside of the surface.

Most shading models employ the fundamental concepts for the effects of specular, diffuse, and ambient lighting.

Specular shading (or lighting—the terms are usually interchangeable in this context) corresponds to the reflective effect seen to some extent on most smooth surfaces; sparkles on water, the white highlights on an apple under kitchen lights, and so on. The strength of specular effects at any point on a surface depends on both the angle of incoming light with respect to the normal of the point being lit, and the angle at which that point is viewed by the observer.

Diffuse shading has to do with the fact that parts of an object directly facing a light source will be lit more brightly than those at an oblique angle to the same light source. For example, a torchiere-type light illuminates the ceiling directly above it more brightly than areas of the ceiling that are a bit off to the side. Some of this effect is due to distance, but much of it is due to the diffuse shading effect, as the angle at which light strikes the ceiling changes. In standard light models, the effect of diffuse shading is dependent on the angle at which light strikes a surface, but not on the angle from which the viewer views that surface.

Ambient light corresponds to the idea of general illumination coming from all sources. It is similar to the effect that would be seen in a room in which the walls, floor, and ceiling are all entirely covered in some sort of flat-panel lighting. In the real world, a very cloudy day (in which shadows largely disappear) is probably the most common scenarios that give an effect similar to ambient light.

Hence, in their most fundamental form, basic shaders may be thought of as being defined by three components: a specular, diffuse, and ambient components. The final appearance of a 3D graphical object is determined by the settings for these components, as lit by the virtual lighting environment set up inside the computer.

However, the lighting and shading models described above are, in spite of their wide use, a tremendous simplification of the way in which light in the real world interacts with object surfaces. For example:

Most specular highlights, like those off of a beach ball, orange, etc., are white. But some, such as glints from a copper or gold coin, are the same color as the material from which they are reflected. To take this into account, an additional setting is provided in shading models.

The standard models normally make multiple unspoken assumptions such as assuming that the diffuse effect for, say, blue light is the same as that for, say, red light. But such assumptions may not be valid for real-world objects.

Even for the most basic elements of standard shading models, the algorithms and mathematical models used to calculate specular, diffuse, and ambient effects, do not necessarily reflect the complexities of real-world lighting. As a result, several different basic shading models exist.

In summary, describing the optical properties of a surface using shading models is difficult and requires both complex algorithms, and many different settings regardless of which algorithm is used. This can significantly affect the usability of these models.

A second factor affecting the appearance of an object in a computer-generated scene is the lighting applied to that object. In most cases, this lighting is actually accomplished by defining “virtual lights” in the computer, placing them in the scene relative to the object or objects being illuminated, and then performing complex and time-consuming calculations to produce the final image.

As with shading models, this process may become very complex because light sources in the real world can be very complex. Even the simplest set of features for producing realistic-looking images requires lights that satisfy the following needs:

Lights may need to be of different colors.

Provisions need to be made for point-source lights (such as a match seen from a distance) or for area lights (such as a fluorescent light), which emit light over a discernible area.

Lighting may come from many different directions. The complexity of this process is best understood with an example. Consider an outdoor scene with a red-colored setting sun, clouds above the sun, and the remainder of the sky clear. The sky will be blue near the sun, fading to indigo near the other horizon. The moon is visible near the darkest part of the sky.

All of the following light sources affect the final result:

The sun.

The light reflected off of the clouds near the sun.

The moon.

The sky itself.

The sky is typically the most complex of the light sources, since it is not only a very large area light, but also one in which both the intensity and the color of the light it provides depend on the point from which that light comes. While this is not the most powerful light source in the scene, taking it into account is generally necessary for a convincing final image. In most 3D applications, simulating the lighting for the sun and moon may be relatively simple, which still translates to a significant amount of effort, as lights may need to be created, and settings adjusted many times, until the desired result was obtained. The reflected light from the clouds generally requires more effort. Simulating the lighting from the sky generally involves a great deal of effort. This is generally done by creating dozens or even hundreds of lighting sources around the scene, and then manually adjusting the color and intensity of each.

Within the field of 3D computer graphics, special lighting effects are typically obtained by having the user construct a simulated lighting environment, and build a virtual scene containing placed lights and objects with surface materials defined numerically in a 3D authoring program. These software tools use lighting algorithms to render the virtual environment. In fact, the appearance of these surfaces may only be fully realized after running a “final render” in these 3D art tools, which could take time, and the look of which is not then easily transferable to other 3D authoring tools.

Embodiments of the present invention allow an artist to create surface materials for rendering a 3D object by simply sampling surface material data from existing images. In this regard, a user-interface is provided which allows the artist to create the surface shaders in a fast and intuitive manner, and does not require the user to understand and adjust large sets of numerical values for creating such surface shaders as is done in prior art rendering systems. The various embodiments of the present invention have wide-ranging applications, including digital photo enhancement, 3D graphics previewing, and the production of final 3D images.

In general terms, embodiments of the present invention provide a way of creating and applying a surface material's appearance including its color, shading, and specularity, in order to obtain high-quality final results with significantly less effort than what is provided by the prior art. The process may be thought of as “reconstructive shading and lighting.” Traditional approaches rely on setting up computational models of lights and surfaces, and then modifying those models until a desired final appearance is reached. In contrast, the approach taken according to various embodiments of the invention is to take a desired appearance of a reference object as a starting point, and from that, capturing the reference material's look, created via different shading and lighting effects, in order to apply the captured look to other objects.

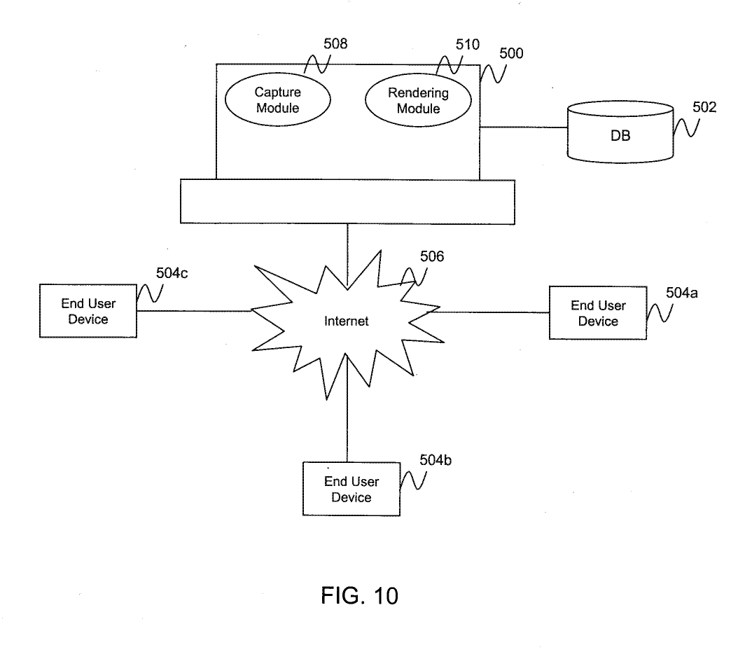

FIG. 10 is a schematic block diagram of a system for creating and applying surface shaders according to one embodiment of the invention. The system includes a server 500 coupled to various end user devices 504a-504c (collectively referred to as 504) over a data communications network 506 such as, for example, a public Internet. The server 500 includes one or more software modules for creating and applying surface shaders. Such software modules may include a capture module 508 for capturing a surface appearance of a reference image or object, and a rendering module 508 for applying the captured surface appearance to a 3D model. According to one embodiment of the invention, the capture and rendering modules are provided in a 3D authoring program hosted by the server.

The server 10 is coupled to a mass storage device 502 such as, for example, a disk drive or drive array, for storing information used by the server 500 for creating and applying surface shaders. For example, the mass storage device may store reference images, captured material data, generated 3D models, and any other information needed for creating and applying surface shaders.

According to one embodiment of the invention, the end user devices 504 may connect to the data communications network using a telephone connection, satellite connection, cable connection, radio frequency communication, or any wired or wireless data communication mechanism known in the art. The users of the end user devices 504 may connect to the server 500 for downloading the capture module 508 and rendering module 510 from the server, or executing these modules remotely from the end user devices. If downloaded to the end user devices 504, the capture and rendering modules 508, 510 may be provided as a single downloadable file. Once downloaded, the capture and rendering modules 508, 510 may be executed locally by one or more processors resident in the downloading end user device. The information stored in the server's mass storage device 502 will also instead be stored locally in a data store coupled to the downloading end user device. According to another embodiment, the capture and rendering modules 508, 510 are provided in a computer readable media and delivered to a user of the end user device for installation.

Regardless of whether the image capture module 508 or rendering module 510 is executed by the server 500 or locally by the end user devices 504, the modules provide multiple flexible ways during 3D rendering to quickly generate the correct look on a surface. This process can easily be used with pre-existing or painted images to produce the information necessary to achieve, with computer generated 3D objects, the same surface appearance as shown in the original images. More abstract user interfaces are also possible, to easily capture the surface materials that achieve other effects.

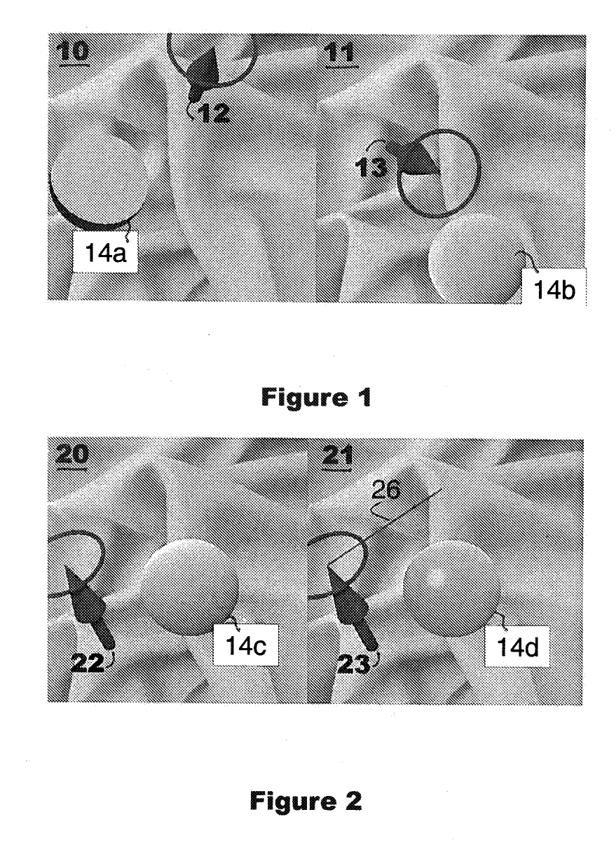

FIGS. 1-2 are photographic images of a user interface provided by the image capturing module 508 for capturing and calibrating surface color, shading, and specularity (collectively referred to as shading information) according to one embodiment of the invention. Referring to FIG. 1, an artist invokes the capture module 508 and utilizes a user interface provided by the image capture module to select a reference image such as, for example, the image of a cloth material. The reference image may be one that already contains the color, shading, and specularity that he or she wants to emulate in rendering an 3D graphical object. Of course, the artist is not limited to just emulating the shading properties of the reference image, but may deviate or add other shading properties for the surface shader created based on the reference image.

In capturing the surface appearance of the reference image, the artist utilizes the user interface to place one or more markers 12, 13, 22, 23 on different portions 10, 11, 20, 21 of the image. For example, the artist may place some markers 12, 13 on non-specular parts of the image, and other markers 22, 23 on specular parts of the image. As the number of markers placed on the reference image increases, so does the ability of the capture module 508 to create a surface shader that more closely emulates the surface appearance of the reference image.

The points on the reference image identified by the placed markers are sampled for obtaining shading information associated with the sampled points. According to one embodiment of the invention, the markers are embodied as vectors that may be rotated by the artist by manipulating a user input device (e.g. a mouse) to approximate a hypothetical colored light source that causes the sampled location to have a particular color. According to one embodiment of the invention, the artist places and rotates the markers in order to specify the perceived normal at the surface location in the image. The orientation information is then stored in association with the marker. Of course, the artist need not rotate the markers in the normal direction, and in fact, may decide to rotate the markers in a different orientation if he or she would like to deviate from the orientation of the color in the reference image.

The artist also manipulates a user input device to interactively specify a fall-off rate (specularity) of the vector. For example, movement of the user input device to the left or right after generating a marker and prior to release of the user input device allows the artist to intuitively decrease or increase the specularity associated with the marker. The different fall-off values stored in association with the various markers help to distinguish between vectors that represent diffuse shading (slow fall-off, as shown via marker 22) and vectors that represent specular (fast fall-off as shown via marker 23) shading.

According to one embodiment of the invention, the capture module 508 identifies a pixel location of the base of each placed vector, and retrieves the color associated with the pixels that fall within a user-controlled distance (radius) 26 from the base of the vector. An average of the colors of all pixels within the defined radius 26 is then stored in association with the placed marker. The average may also be a weighted average with less weight given to the pixels further away from the base of the vector.

According to one embodiment of the invention, in addition to the orientation, color, and fall-off values stored in association with each marker, the user interface provided by the capture module 508 allows the artist to define or alter a strength value for each marker. In this regard, all markers are assigned an equal strength value by default. However, if the artist would like a particular marker to be given more weight in generating the surface shader, the artist may assign a higher strength value to such marker.

According to one embodiment of the invention, a surface shader is generated as a hemisphere image 14a-4d and updated in real-time with the addition of each new marker in order to give immediate feedback to the artist of the captured appearance of the surface on which the markers are placed. The hemisphere image is generated based on the orientation, color, fall-off value, and optionally, the strength value, associated with each marker. As the surface shader is calibrated with the addition or deletion of each marker, or the adjusting of the fall-off rate of one or more markers, the hemisphere image is likewise calibrated and re-displayed in real-time. After the material has been captured to the artist's satisfaction, it can then be applied to a 3D computer generated object.

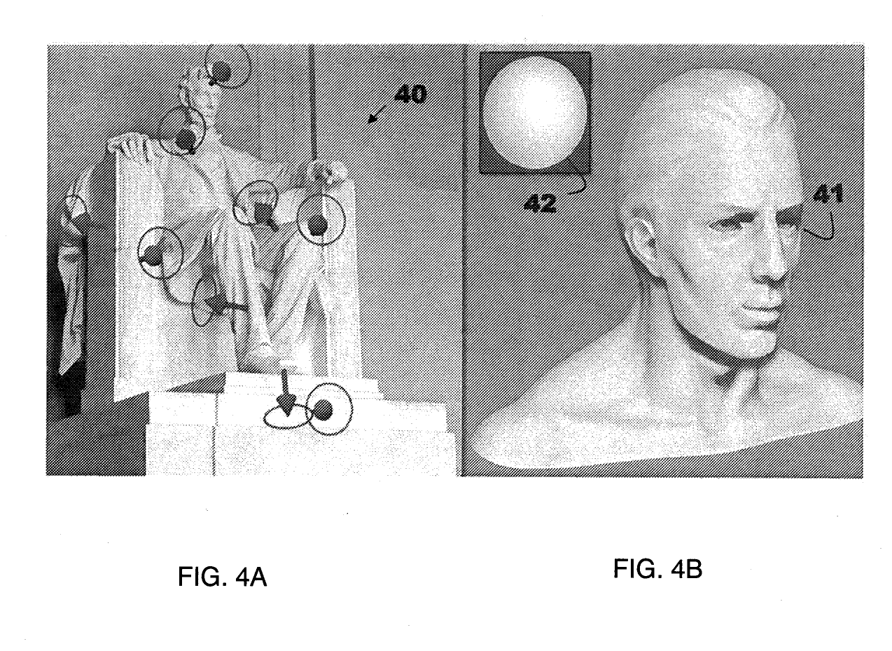

FIG. 4A is a photographic image of statute 40 with various markers placed on the image for capturing and calibrating shading information of the surface surrounding the markers according to one embodiment of the invention. The capture module 508 takes the orientation, color, and fall-off values associated with each marker, and generates an associated hemisphere image 42 as is shown in FIG. 4B. This hemisphere image is stored in memory or in a computer file at the server 500 (e.g. in the mass storage device 502) or at the end user device 504. FIG. 4B further provides a photographic image of a test object, in this example, a 3D computer model 41, rendered according to the shading information captured from the image of the statute 40 according to one embodiment of the invention.

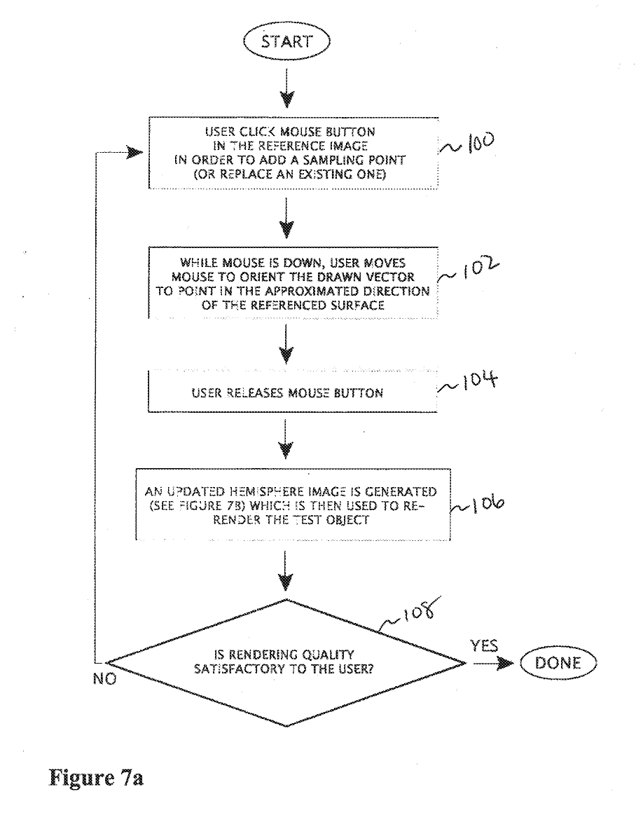

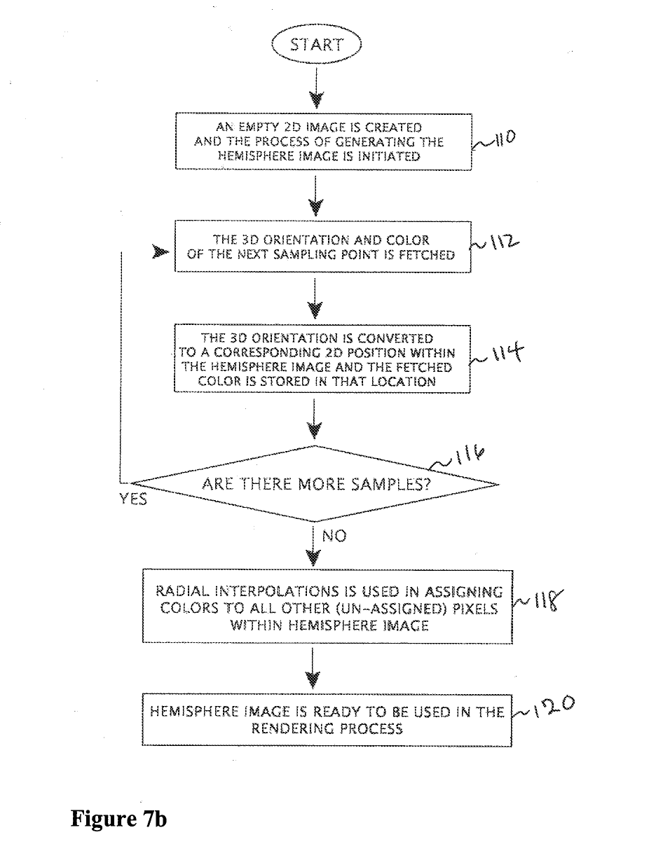

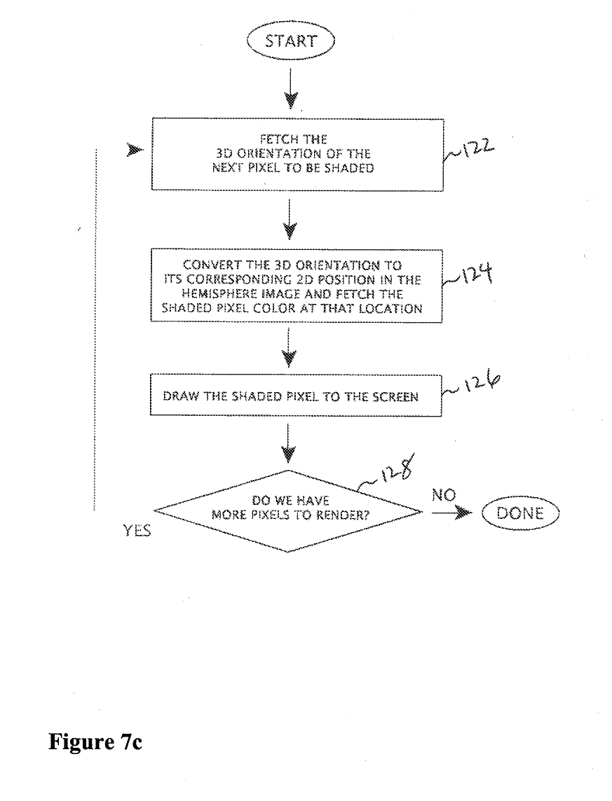

Rendering from the hemisphere image is a simple lookup to get the pixel on the hemisphere's image whose normal closest to the surface normal of the current 3D object being drawn as is discussed in more detail below with respect to FIG. 7C. According to one embodiment of the invention, an algorithm processes normal and color pairs that have been collected for both front and back views of the object, and generates a full, or portion of, a sphere instead of the image of a hemisphere, as output.

An example workflow than an artist may employ, is to start with a predefined reference image, such as, for example, a photograph of a vase, or of a statue like the one shown in FIG. 4A, or a sofa, or any other object, in a particular lighting environment. With a specialized and simple user interface provided by the capture module 508, the artist then specifies the color and its corresponding angle (surface normal) at various points on the object. The capture module 508 then automatically extracts and processes lighting and shading information, currently to an image of a hemisphere 42 shown in FIG. 4B, and that information may then be applied to other 3D objects. The artist may continue to refine or calibrate the look of the captured material by supplying additional normal and color pairs until the desired look is achieved.

If the artist is trying to capture material properties in a virtual environment, such as an alien planet, or one that is difficult to specify, such as a sunset or strange lighting in a cave, then the artist may either create a representative 3D object, or paint an image as a way of illustrating the special lighting and shading effects. This image of the 3D object or painting (which can additionally be from a digital or scanned image) is then be processed, as described previously, to obtain lighting and shading effects that might not be obtainable from real-world images.

FIG. 7A is a flow diagram of a process executed by the capture module 508 for sampling points in a reference image for capturing and calibrating shading information of the surface surrounding the sampled points according to one embodiment of the invention. In step 100, the capture module 508 detects that the user has clicked a mouse button (or some other user input device) on the reference image, and identifies the pixel associated with the clicked point. While the mouse is down, the user moves the mouse to draw a vector, such as, for example, vectors 12, 13, 22, 23, and orients the drawn vector to point in a direction approximated to be a normal (or some other orientation) from the referenced surface in step 102.

In step 104, the user releases the mouse button. The capture module 508 detects the location of the mouse as the mouse is released, and from this information, identifies the angle of the vector in relation to the surface. Prior to releasing the mouse, the user may also press a first control button on the user input device and move the device away from the base of the vector to specify a radius from the base, and/or press a second control button and move the input device in a first or second direction to modify a default fall-off value assigned to the marker. According to one embodiment of the invention, the default fall-off value corresponds to a wide beam that may be produced, for example, by a flashlight. By manipulating the user input device in the first or second direction after pressing the second control button, the artist is able to modify the default fall-off value to, for example, better match the specularity of the reference image at the marked location.

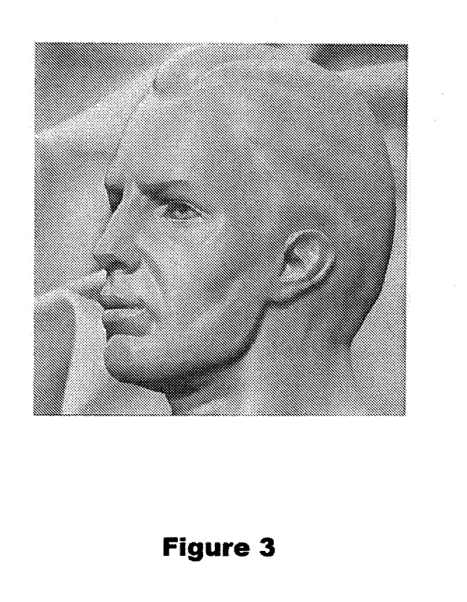

In response to the mouse being released, the capture module renders in step 106, an updated hemisphere image to provide immediate feedback to the artist of the captured and calibrated surface appearance. The updated hemisphere image is in turn used to render a test object, such as, for example, the test object in FIG. 3 or FIG. 4B. The rendering of the test object may occur after the artist has sampled enough points so as to create a hemisphere with a rendering quality that is satisfactory to the artist. Alternatively, the rendering of the test object may occur concurrently with the rendering of the hemisphere image.

In step 108, a determination is made as to whether the artist has indicated that the sampling of the points of the reference image is finished. Such an indication is made if the rendering quality as depicted in the updated hemisphere image is satisfactory to the artist. If the artist is not satisfied, the process returns to step 100 for adding additional markers or replacing existing ones on the reference image.

FIG. 7B is a flow diagram of a process for generating a hemisphere image from the sampled points in FIG. 7A according to one embodiment of the invention. In step 110, the capture module 508 generates an empty 2D hemisphere image.

In step 112, the capture module 508 retrieves for a particular marker (sampling point), the stored color, orientation, and fall-off value captured or interactively defined for the particular marker.

In step 114, the capture module 508 converts the orientation angle to a corresponding 2D position within the hemisphere image according to any conventional mechanism in the art. The retrieved color and fall-off value is then stored in association with the pixel corresponding to the identified 2D position as the pixel's shaded color.

In step 116, a determination is made as to whether there are any more sampling points that need to be processed. If the answer is YES, the process returns to step 110 to process the remaining markers.

After all sampling points have been processed, the capture module 508 engages in radial interpolation or any other technique conventional in the art for assigning colors to the unassigned pixels of the 2D hemisphere image.

The hemisphere image is stored in step 120, and ready to be used in the rendering of any desired test object. In addition, the hemisphere image may be imported to other graphics applications conventional in the art for further modification or altering.

It should be understood by a person of skill in the art that the process described with respect to FIG. 7B occurs as soon as an artist places (or replaces) a particular marker, and releases the mouse. The constant updating of the hemisphere image with the addition or replacing of each sample point allows the artist to have immediate feedback on the surface shader that is being created.

It should also be understood by a person of skill in the art that although the 2D image is described in the various embodiments as being a hemisphere, any other 2D image may be used instead of a hemisphere. A hemisphere is chosen to describe the various embodiments because it is a well recognized and intuitive primitive image that may be used as the surface shader.

FIG. 7C is a flow diagram of a process executed by the rendering module 510 for using the surface shader generated in FIG. 7B for rendering an arbitrary 3D object according to one embodiment of the invention. The process starts, and in step 122, the rendering module 510 retrieves the 3D orientation of a particular pixel of the 3D object to be shaded.

In step 124, the rendering module 510 converts the retrieved 3D orientation to its corresponding 2D position in an identified hemisphere image as is conventional in the art, and retrieves the shaded pixel color for the identified 2D position.

In step 126, the rendering module 510 proceeds to draw the particular pixel of the 3D object according to the retrieved shaded pixel color.

In step 128, a determination is made as to whether there are more pixels of the 3D object to render. If the answer is YES, the process returns to step 122.

Although the above embodiments contemplate the generating of the 2D hemisphere image to test the rendering quality based on the shading information obtained from the sampling of the reference image, a person of skill in the art should appreciate that the generating of such a 2D hemisphere image is optional, and may altogether be skipped according to alternative embodiments of the invention. This is because the ultimate goal of the artist is to obtain shading information from the reference image to apply this shading information to a 3D test object. The 2D hemisphere image simply allows the artist to test how the rendering would look in a quick and efficient manner. If the generating of the 2D hemisphere image is skipped, the sampled shading information is directly applied to the 3D test object for rendering the object.

Alternative Material Capture Interfaces

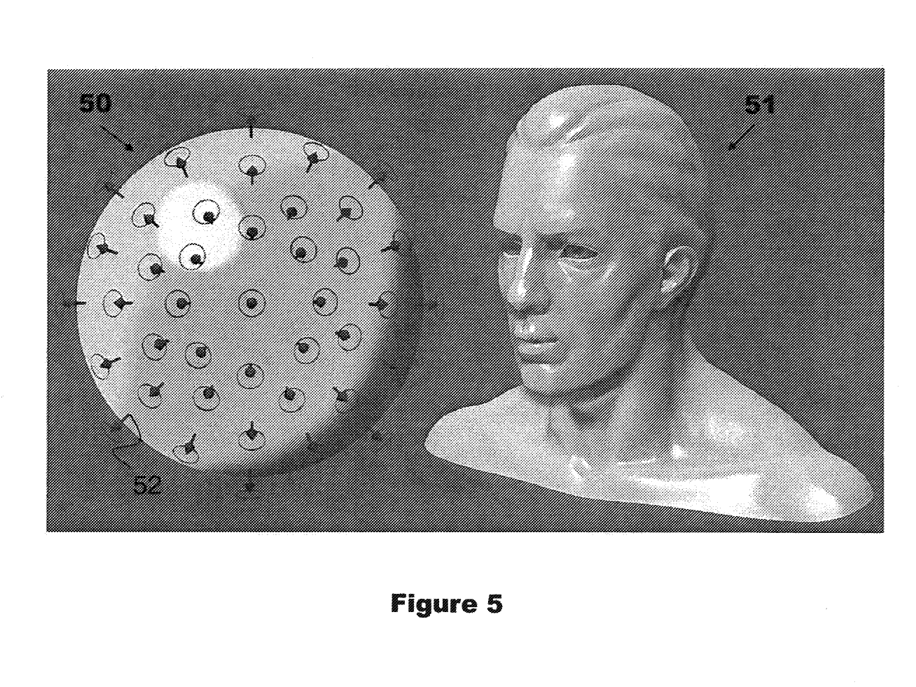

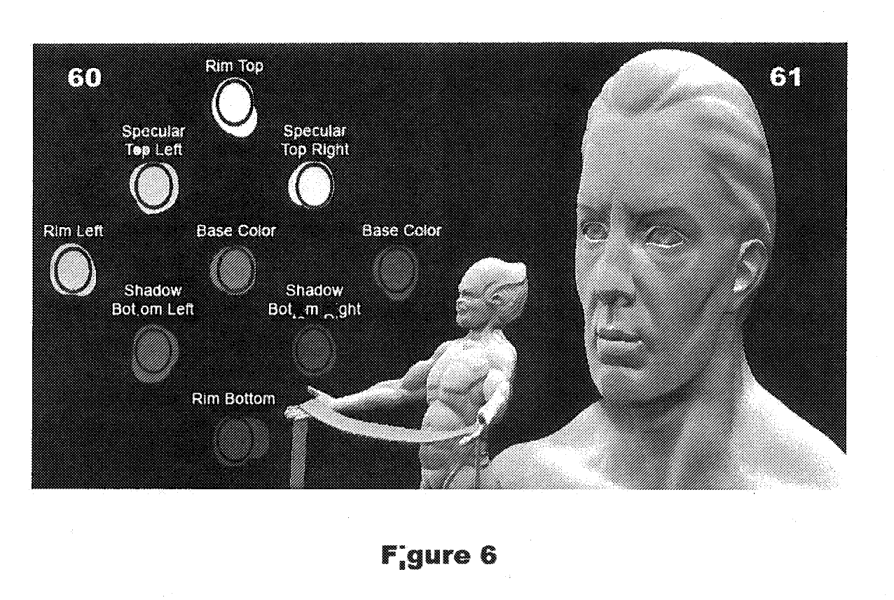

The capture module 508 may provide alternative user interfaces to allow an artist or other users to define lighting and shading effects based on a more abstract approach, such as specifying the look of surfaces at particular predefined angles or important surface attributes. FIGS. 5 and 6 illustrate two alternative user interfaces that may be presented to the artist to allow quick specification of a surface material. The choice of interface provided may depend on the surface material being captured, the preferred workflow of the artist or art director, or other factors.

The first alternative user interface shown in FIG. 5 uses a predefined hemisphere 50 for color input, via digital painting, by the artist. The hemisphere 50 is presented with a set of fixed normals 52. The artist paints the hemisphere 52 with the desired color and shading for the given normal angles. A preview object 51 is updated in real-time based on the color and shading given to the hemisphere 52 to give feedback to the artist for the material being created.

FIG. 6 illustrates a second alternative interface where information that is significant in the shading and specular highlighting of a surface has been predefined as labeled circular areas 60. The artist has painted sample colors into the circles 60, and a preview object 61 is updated in real-time to provide feedback allowing the artist to evaluate and fine-tune the material. This particular interface for surface material capture helps to allow a manager, such as a Technical Director, to have more control of the final results achieved by artists who define lighting via painting.

Physical interfaces may even be used as input to the material capture process described according to the various embodiments of the invention. A pen-like device that samples the color and normal angle on a real-world object, such as a plastic ball may, for example, be used to provide the color and orientation inputs to the capture module 508. For example, various light sensing devices configured to also detect orientation of the device in reference to a pointed object exist in the art, and any such devices may be used to provide color and orientation input to the capture module 508 The orientation information may alternatively be manually entered by the user. A digital camera may also be used to provide color information to the capture module.

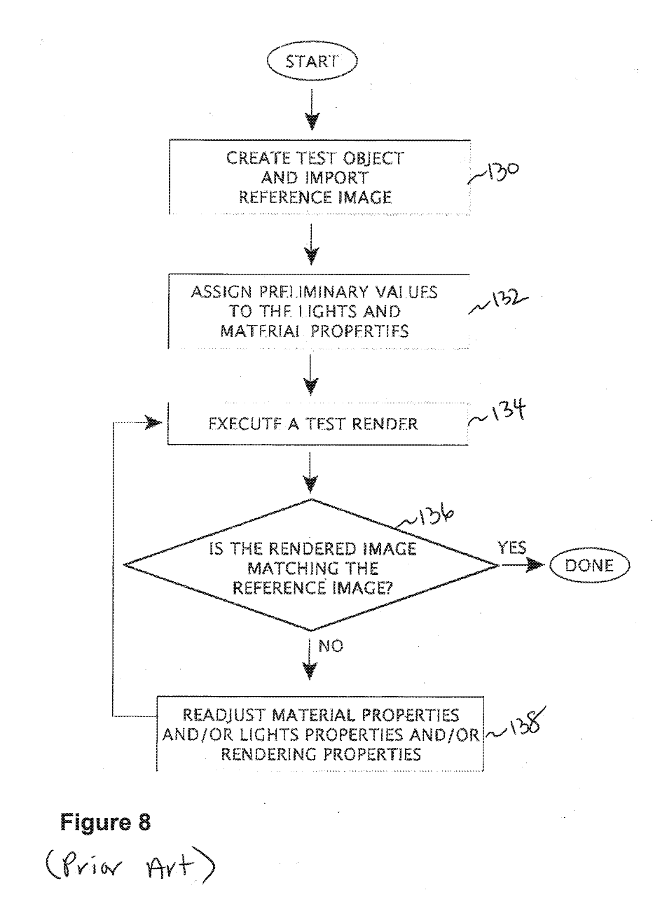

In order to illustrate the advantages of the present system and method for generating surface shaders, it will be useful to consider an exemplary prior art process for specifying shading information. FIG. 8 is a flow diagram of such an exemplary prior art process. In step 130, the user invokes a 3D rendering tool to create a test object, such as, for example, a 3D computer generated object. The user then imports a reference image that he or she wants to use as a basis for rendering the test object.

In step 132, the user invokes the 3D rendering tool to construct a simulated lighting environment and material properties, and assigns preliminary numerical values for each of the light and material properties.

In step 134, a test rendering of the test object is executed according to the assigned numerical values.

In step 136, a determination is made as to whether the rendered image matches the reference image. If the answer is NO, the user invokes the 3D rendering tool in step 138 to readjust the material properties, light properties, and/or rendering properties, and the process returns to step 134 to re-render the test object.

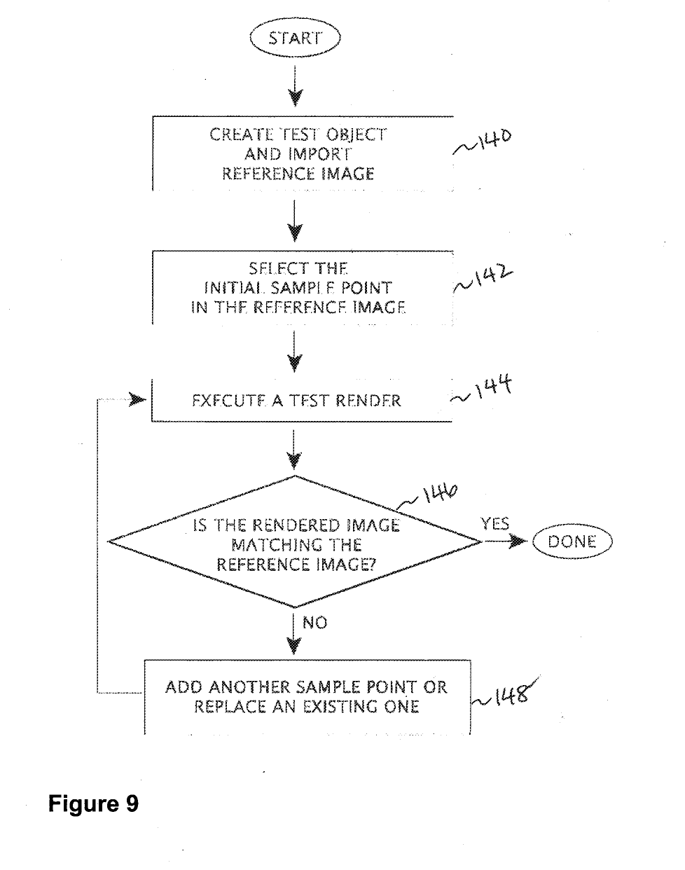

The process described with respect to FIG. 8 may be contrast with the improved process for creating surface materials according to the various embodiments of the present invention. FIG. 9 is a flow diagram of such a process. In step 140, the capture module 508 is invoked to create a test object, such as, for example, a clay model of such an object. The user then invokes the capture module 508 to import a reference image that has a surface appearance that the user would like to emulate for the test object.

In step 142, the capture module 508 detects user selections of initial sample points on the reference image, and executes the processes described above with respect to FIGS. 7A-7B to generate the hemisphere image.

In step 144, the rendering module 510 is invoked according to the process described above with respect to FIG. 7C to execute a testing rendering of the test object.

In step 146, a determination is made as to whether the rendering is complete due to the user's determination that the surface appearance of the rendered image matches the surface appearance of the reference image. If the answer is NO, the artist adds another sample point or replaces an existing sample point in step 148, and the process returns to step 144 to re-render the test object.

It should be appreciated that the various embodiments of the present invention offer significant advantages compared to existing techniques. Using the above described system and method for creating surface shaders, artists can quickly create surface materials that, if implemented using existing techniques, would require complex setup and time-consuming experimentation to achieve the same final look.

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A computer-implemented method for creating and applying a surface shader, the method comprising:
displaying a reference image on a display;
placing one or more markers on the reference image;
sampling one or more points on the reference image identified by the placed markers;
obtaining shading information associated with the sampled points;
shading a 3D object based on the shading information; and
displaying the shaded 3D object on the display.

2. The method of claim 1, wherein the sampling of the one or more points includes obtaining color information for the one or more points.

3. The method of claim 1, wherein the sampling of the one or more points includes obtaining an orientation of the placed markers.

4. The method of claim 1, wherein the shading information includes color, orientation, and specularity for the one or more points.

5. The method of claim 4, wherein the specularity is interactively determined for each marker responsive to a user manipulation of a user input device.

6. The method of claim 1 further comprising:
generating a 2D image with the obtained shading information for testing a rendering based on the shading information.

7. The method of claim 6, wherein the 2D image is a hemisphere.

8. The method of claim 6, wherein the 2D image is updated in real-time in response to the placement of each marker.

9. The method of claim 6, wherein the 2D image depicts a surface appearance of the reference image surrounding the sampled points.

10. The method of claim 6, wherein the shaded 2D image depicts a surface appearance of the 2D image.

11. The method of claim 1, wherein the shaded 3D object depicts a surface appearance of the reference image surrounding the sampled points.

12. The method of claim 1, wherein the markers are vectors placed on the reference image.

13. A system for creating and applying a surface shader, the system including:
a processor;
a memory operably coupled to the processor and having program instructions stored therein, the processor being operable to execute the program instructions, the program instructions including:
displaying a reference image;
providing a user interface for placing one or more markers on the reference image;
sampling one or more points on the reference image identified by the placed markers;
obtaining shading information associated with the sampled points;
shading a 3D object based on the shading information; and
a display coupled to the processor for displaying the shaded 3D object.

14. The system of claim 13, wherein the program instructions include:
generating a 2D image with the obtained shading information for testing a rendering based on the shading information.

15. A computer readable media embodying program instructions for execution by a processing device, the program instructions adapting the processing device for creating and applying a surface shader, the program instructions comprising:
displaying a reference image on a display;
placing one or more markers on the reference image;
sampling one or more points on the reference image identified by the placed markers;
obtaining shading information associated with the sampled points;
generating a 2D image with the obtained shading information;
shading a 3D object based on the generated 2D image; and
displaying the shaded 3D object on the display.

16. The computer readable media of claim 15, wherein the program instructions include:
generating a 2D image with the obtained shading information for testing a rendering based on the shading information.
